(19) United States
(12) Patent Application Publication
(10) Pub. No.: US 2026/0312708 A1
(43) Pub. Date: Oct. 8, 2026

(54) SELF-SUPERVISED METHOD FOR ACCELERATED TRAINING OF NEURAL COMMUNICATION RECEIVERS

(71) Applicant: UT-Battelle, LLC, Oak Ridge, TN (US)

(72) Inventor: Corey Cooke, Knoxville, TN (US)

(21) Appl. No.: 19/634,574

(22) Filed: Mar. 31, 2026

Related U.S. Application Data
(60) Provisional application No. 63/783,942, filed on Apr. 4, 2025.

(51) Int. Cl. H04B 17/391; H04B 7/0456; H04W 24/02; H04W 24/06

(52) U.S. Cl. CPC H04B 17/3913; H04B 7/0456; H04W 24/02; H04W 24/06

(57) ABSTRACT

Self-supervised learning (SSL) techniques are applied to training neural-network-based communication receivers using unlabeled radio frequency (RF) message signals. In one aspect, an encoder model is pretrained using contrastive learning in which positive pairs are generated by transmitting an identical input message through multiple realizations of a stochastic communication channel to produce distinct received message signals. Negative pairs are generated from received message signals corresponding to different input messages. The encoder model is trained to produce representation signals that are similar for positive pairs and dissimilar for negative pairs. The pretrained encoder model is then used to facilitate supervised training of a neural receiver model to reconstruct transmitted messages from received RF signals. By leveraging channel-induced variations during pretraining, the disclosed approach reduces supervised training time and improves receiver performance under varying channel conditions.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### BACKGROUND OF THE INVENTION

The present disclosure relates generally to wireless communication systems and, more particularly, to machine-learning-based communication receivers. Specifically, the disclosure relates to techniques for accelerating the training of neural network-based communication receivers through self-supervised pretraining.

In a digital communication system, an input symbol sequence is encoded into a waveform by a transmitter, transmitted through a physical channel that introduces distortion and noise, and processed by a receiver to recover an estimate of the original symbol sequence. The objective of the system is to reproduce the transmitted information while minimizing metrics such as power consumption, bandwidth usage, latency, and bit error rate. From a systems perspective, the concatenation of transmitter, channel, and receiver can be viewed as performing the function of an autoencoder, mapping transmitted symbols to reconstructed symbols.

In practical wireless environments, the channel is typically modeled as a random linear time-varying system that may include multipath fading and additive noise. Transmitter and receiver architectures have traditionally been designed using analytical models of such channels. However, analytical receiver structures may not fully capture stochastic channel variation, nonlinear impairments, or hardware effects encountered in real deployments.

Recent advances in machine learning have led to the application of artificial neural networks (ANNs) within communication systems. In particular, neural networks have been proposed to implement receiver functions for demodulation and decoding in systems such as orthogonal frequency division multiplexing (OFDM) operating over stochastic channel models. In such architectures, the receiver processes digitized in-phase and quadrature (I/Q) samples and produces reconstructed symbol or bit estimates, including soft-decision outputs such as log-likelihood ratios (LLRs).

Although neural receivers can adapt to complex channel conditions, they typically require extensive supervised training. Supervised training involves generating labeled datasets in which received signal samples are paired with known transmitted bit sequences. Under realistic multipath and fading environments, neural receiver training may require substantial data volume and many training epochs before convergence to acceptable bit-error-rate (BER) performance. This training burden can limit responsiveness and adaptability in dynamic wireless systems. Separately, self-supervised learning (SSL) has emerged as a machine learning paradigm for leveraging unlabeled data to learn feature representations. SSL approaches seek to extract intrinsic structure from input data without requiring explicit external labels. Various categories of SSL have been proposed, including generative methods, contrastive methods, and hybrid generative-contrastive approaches.

Contrastive SSL, in particular, trains an encoder to map input samples into a latent representation space in which related samples are encouraged to be close and unrelated samples are encouraged to be separated. Such approaches commonly generate multiple augmented versions of an input sample and apply a contrastive loss, such as a normalized temperature-scaled cross-entropy loss, to encourage representation similarity between positive pairs while distinguishing negative pairs.

Contrastive SSL techniques have been applied in a variety of domains, including image processing and signal analysis. More recently, contrastive learning has been applied to radio-frequency (RF) signal analysis tasks such as automatic modulation classification, where unlabeled I/Q samples are augmented and an encoder is trained to produce representations suitable for downstream classification of modulation types.

Despite these developments, training neural-network-based communication receivers under stochastic wireless channel conditions remains computationally intensive. In particular, supervised training approaches for such receivers may require large labeled datasets and extended training durations to achieve satisfactory decoding performance.

Techniques that leverage unlabeled RF data to improve or accelerate the supervised training of neural communication receivers may therefore provide practical advantages. Approaches that reduce training time while maintaining or improving decoding performance could facilitate deployment of machine-learning-based receivers in wireless communication systems, including OFDM-based systems operating over stochastic fading channels.

### SUMMARY OF THE INVENTION

The present disclosure provides systems and methods for accelerating the training of neural-network-based communication receivers through self-supervised pretraining of an encoder model.

In one aspect, a system includes radiofrequency (RF) interface circuitry configured to receive RF signals carrying transmitted messages through an RF communications channel and to digitize the received RF signals to produce message signals. The system further includes a data processing apparatus configured to pretrain an encoder model using contrastive self-supervised learning based on a first set of message signals, and to train a neural receiver model using supervised learning based on a second set of message signals.

During the pretraining phase, pairs of message signals corresponding to identical or similar transmitted messages that have propagated through stochastic channel realizations are processed to generate positive sample pairs, while message signals corresponding to different transmitted messages are processed to generate negative sample pairs. The encoder model is trained such that representation signals produced from positive pairs are encouraged to be similar in a latent representation space, and representation signals produced from negative pairs are encouraged to be dissimilar.

After pretraining, the encoder model is applied to message signals associated with labeled training messages to produce representation signals that are provided to the neural receiver model. The neural receiver model is trained using supervised learning to reconstruct transmitted messages from the representation signals. In some embodiments, the encoder model remains trainable during supervised receiver training.

In operation, the pretrained encoder model processes a received message signal associated with a test message to generate a representation signal, and the trained neural receiver model reconstructs the transmitted test message from the representation signal. The reconstructed message may be output as a bit sequence or as soft-decision values including log-likelihood ratios.

In certain embodiments, the RF signals are generated using an orthogonal frequency division multiplexing (OFDM) protocol and are transmitted over stochastic multipath fading channels. The contrastive pretraining phase may utilize independently realized channel distortions of identical transmitted messages to generate positive pairs representative of channel-induced variations.

By leveraging unlabeled RF data during the contrastive pretraining phase, the disclosed approach reduces the number of supervised training epochs required for the neural receiver to converge to a target decoding performance level. In this manner, overall receiver training time may be reduced while maintaining or improving bit-error-rate performance under realistic channel conditions.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a schematic block diagram of an example communication system including a transmitter, a communications channel, radio frequency (RF) interface circuitry, a pretrained encoder model, and a neural receiver model configured to reconstruct transmitted messages.

FIG. 2 is a block diagram illustrating a self-supervised contrastive pretraining system for an encoder model, in which message signals corresponding to transmitted messages are processed by the encoder model to produce representation signals, and a contrastive loss function is applied to train the encoder model based on similarities and dissimilarities among the representation signals.

FIG. 3 is a representative schematic diagram illustrating generation of positive sample pairs by transmitting an identical message sequence through independent stochastic channel realizations to produce distinct message signals for contrastive pretraining.

FIG. 4 is a representative schematic diagram illustrating generation of negative sample pairs by transmitting differing message sequences through independent stochastic channel realizations to produce distinct message signals for contrastive pretraining.

FIG. 5 is a block diagram illustrating supervised training of a neural receiver model using representation signals generated by the pretrained encoder model.

### DESCRIPTION OF THE CURRENT EMBODIMENTS

The present disclosure relates to training and operation of a neural-network-based communication receiver in which an encoder model is trained using self-supervised contrastive learning on received message signals. Unlike conventional approaches that rely solely on labeled training data, the disclosed techniques leverage unlabeled radio frequency (RF) message signals to learn representations that capture channel-induced variations. These learned representations are then used to improve the efficiency and convergence behavior of a downstream neural receiver tasked with reconstructing transmitted messages from received signals.

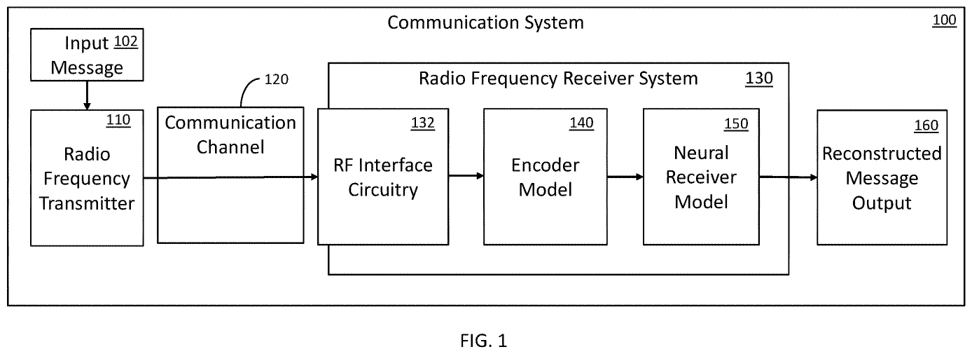

FIG. 1 illustrates an exemplary communication system 100 configured to transmit and process an input message 102 using a neural-network-based receiver architecture. The communication system 100 includes a radio frequency (RF) transmitter 110, a communication channel 120, and a radio frequency receiver system 130.

The RF transmitter 110 is configured to encode an input message 102, such as a bit sequence or symbol sequence, into an RF signal suitable for transmission. The encoded signal is transmitted through the communication channel 120, which may introduce distortion, noise, and other impairments. In certain embodiments, at least a portion of the communication channel 120 comprises a radio frequency (RF) propagation environment through which the RF signal propagates. The communication channel 120 may represent a wireless communication medium, including but not limited to cellular, Wi-Fi, or satellite communication environments, and may exhibit stochastic, time-varying behavior including multipath fading and additive noise.

The RF receiver system 130 is configured to process received RF signals to recover the transmitted message. The RF receiver system 130 includes RF interface circuitry 132 configured to receive RF signals from the communication channel 120 and to digitize the received RF signals to produce message signals, such as in-phase and quadrature (I/Q) sample vectors.

The RF receiver system 130 further includes an encoder model 140 configured to process the message signals to produce corresponding representation signals, and a neural receiver model 150 configured to reconstruct transmitted messages from the representation signals. In certain embodiments, the encoder model 140 and the neural receiver model 150 are implemented as artificial neural networks. In certain embodiments, the encoder model 140 is pretrained using self-supervised contrastive learning, as described further below.

The neural receiver model 150 produces a reconstructed message 160 based on the representation signals. In some embodiments, the reconstructed message 160 comprises a bit sequence or soft-decision outputs, such as log-likelihood ratio (LLR) values, corresponding to the transmitted message.

In operation, RF signals transmitted by the RF transmitter 110 propagate through the communication channel 120 and are received by the RF interface circuitry 132. The digitized message signals are processed by the encoder model 140 to generate representation signals, which are then processed by the neural receiver model 150 to reconstruct the transmitted message.

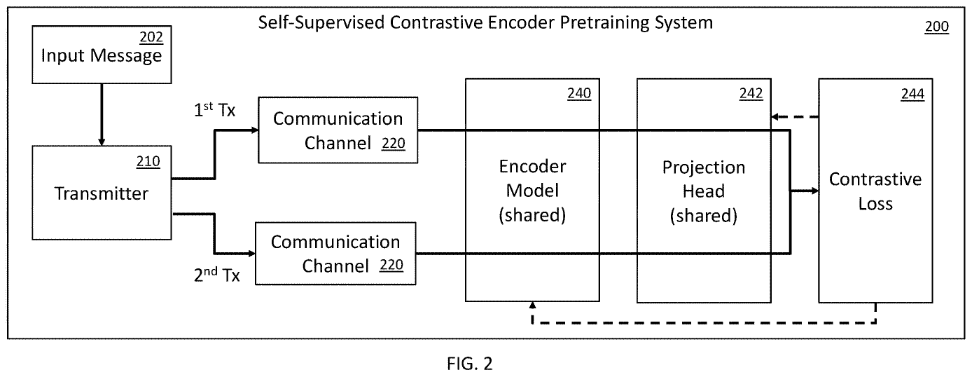

In certain embodiments, the encoder model 140 is trained using a self-supervised contrastive learning process that leverages unlabeled message signals to learn representations of received signals. The learned representations may be used to improve the efficiency and convergence behavior of downstream processing, including supervised training of the neural receiver model 150 in certain embodiments. FIG. 2 illustrates an example self-supervised contrastive encoder pretraining system 200 configured to perform such pretraining of the encoder model 140. In one embodiment, the self-supervised contrastive encoder pretraining system 200 includes a transmitter 210, a communication channel 220, an encoder model 240, a projection head 242, and a contrastive loss component 244 configured to compute a contrastive loss used to update parameters of the encoder model 240 and the projection head 242. Unlike conventional contrastive learning approaches that rely on synthetic data augmentations applied to a received signal, the disclosed techniques generate positive pairs from distinct received message signals obtained by transmitting an identical input message through independent realizations of a stochastic communication channel.

In certain embodiments, self-supervised contrastive learning is used to train an encoder that learns efficient representations of received message signals. The trained encoder may then be used to enhance the performance and convergence rate of a downstream neural communication receiver.

Self-supervised contrastive learning includes two primary stages. The first stage is self-supervised pretraining of an encoder neural network using unlabeled message signals. The second stage is supervised training of a downstream neural receiver using labeled data.

### Stage 1: Self-Supervised Encoder Pretraining

During the self-supervised pretraining stage, no external data labels are required. Instead, for each input message, multiple received message signals are generated by transmitting the same message 202 from a transmitter 210 through the communication channel 220 multiple times. In certain embodiments, each input message may comprise a bit vector corresponding to one orthogonal frequency division multiplexing (OFDM) symbol (e.g., 104 bits corresponding to two bits per data subcarrier in a 52-subcarrier OFDM system).

During the self-supervised pretraining stage, multiple received message signals may be generated from a single input message by transmitting the same message through the communication channel 220 multiple times. Because the communication channel 220 is stochastic and time-varying, each transmission results in a distinct received message signal. These received message signals, although derived from the same transmitted message, are not identical and correspond to different channel realizations.

Pairs of received message signals derived from the same transmitted message form positive pairs, while received message signals derived from different transmitted messages form negative pairs.

The encoder model 240 is shared across the multiple received message signals such that each received message signal is processed using the same encoder parameters. In this manner, the encoder model learns representations that are invariant to variations present in the received message signals.

In certain embodiments, the representation signals are further processed by a projection head 242 to produce projected vectors. The projection head 242 may be implemented as a neural network trained jointly with the encoder model during pretraining. In certain embodiments, performance is improved when the contrastive loss is applied to the projected vectors produced by the projection head 242 rather than directly to the representation signals produced by the encoder model 240.

A contrastive loss function 244 is applied to the projected vectors to encourage representation signals corresponding to positive pairs to be more similar to one another, while encouraging representation signals corresponding to negative pairs to be more dissimilar. In certain embodiments, the contrastive loss component 244 is used to update parameters of the encoder model 240 and the projection head 242 during pretraining.

In certain embodiments, the projection head maps representation signals into a space in which the contrastive loss more effectively captures similarities and dissimilarities between received message signals.

### Contrastive Loss Formulation

In certain embodiments, the contrastive loss function comprises a normalized temperature-scaled cross-entropy loss (NT-Xent). The loss is computed based on similarities between projected vectors corresponding to pairs of received message signals.

In one example formulation, the contrastive loss for a positive pair of projected vectors denoted by subscripts i and j is defined as:

$${L}_{cont} ( {ω}_{i} , {ω}_{j} ) = - log ( \frac{exp ( sim ( {ω}_{i} , {ω}_{j} ) / τ )}{{\sum }_{k = 1}^{2 M} 1 [ k \neq i ] exp ( sim ( {ω}_{i} , {ω}_{k} ) / τ )} )$$

where ωᵢ and ωⱼ are projected vectors produced by the projection head corresponding to respective received message signals from a positive pair, τ is a temperature parameter that controls the scaling of similarity values in the contrastive loss function, and the function 1[k≠i] is an indicator function. In certain embodiments, M represents the number of input messages used during pretraining, and each input message generates two or more received message signals, resulting in a plurality of projected vectors derived from the same underlying message.

The similarity function may include a cosine similarity between projected vectors, defined as:

$$s i m ( {ω}_{i} , {ω}_{j} ) = \frac{{ω}_{i}^{T} {ω}_{j}}{{‖ {ω}_{i} ‖}_{2} {‖ {ω}_{j} ‖}_{2}}$$

During training, the contrastive loss is computed for all positive pairs within a batch and averaged for backpropagation to update parameters of the encoder model and projection head.

The objective of the pretraining stage is to train the encoder model to map received message signals into a latent representation space such that representations corresponding to positive pairs are closer to one another, and representations corresponding to negative pairs are farther apart.

### Example Encoder and Projection Head Architecture

In certain embodiments, the encoder network includes one or more dense (fully connected) layers with activation functions, such as scaled exponential linear unit (SELU) activation functions. The encoder network is configured to process received message signals and generate corresponding representation signals.

In certain embodiments, the projection head includes a multi-layer perceptron having one or more layers, such as a hidden layer followed by an output layer, and is configured to map representation signals into a space suitable for application of the contrastive loss function.

Example parameters for the encoder network and projection head are provided in Tables 1 and 2. These parameters are provided for illustrative purposes, and other network architectures and configurations may be used without departing from the scope of the present disclosure

TABLE 1
Exemplary Encoder network parameters

| Layer | Outputs | Activation |
|---|---|---|
| Input | 128 | - - - |
| Dense | 512 | SELU |
| Dense | 128 | Linear |

TABLE 2
Exemplary Projection head network parameters

| Layer | Outputs | Activation |
|---|---|---|
| Input | 128 | - - - |
| Dense | 512 | SELU |
| Dense | 64 | Linear |

### Channel Modeling for Pretraining

In certain embodiments, stochastic channel models are used during the self-supervised pretraining stage to simulate variations introduced by a communication channel. The channel models can be configured to produce distinct received message signals from repeated transmissions of the same input message, thereby enabling formation of positive pairs that capture channel-induced variations.

In certain embodiments, the communication channel is modeled as a stochastic, time-varying channel that may include effects such as multipath fading, phase distortion, and additive noise. The stochastic channel models may be configured to generate independent channel realizations for each transmission of an input message. Example channel models include, but are not limited to, tapped delay line (TDL) multipath channel models, such as those specified by the 3rd Generation Partnership Project (3GPP), including both non-line-of-sight (NLOS) and line-of-sight (LOS) variants. In some embodiments, an additive white Gaussian noise (AWGN) channel model is used.

Example parameters for a multipath channel model are provided in Table 3. These parameters are provided for illustrative purposes only, and other channel models and parameter values may be used without departing from the scope of the present disclosure.

TABLE 3
Multipath channel parameters

| Quantity | Value | |
|---|---|---|
| Delay spread | 10 | ns |
| Carrier frequency | 900 | MHz |
| Minimum platform speed | 0 | m/s |
| Maximum platform speed | 5 | m/s |

### Training Procedure

In certain embodiments, the encoder model can be trained during the self-supervised pretraining stage using a set of training parameters. Example pretraining parameters, including batch size, number of training steps per epoch, number of training epochs, optimizer type, learning rate, and loss function, are provided in Table 4. These parameters are provided for illustrative purposes only, and other training configurations may be used without departing from the scope of the present disclosure.

In certain embodiments, randomly generated binary vectors are used as input messages during each training epoch. Because the space of possible input messages is extremely large, the use of randomly generated input messages reduces the likelihood of repeated samples and mitigates overfitting during pretraining.

TABLE 4
Encoder pre-training parameters

| Quantity | Value |
|---|---|
| Batch size | 1024 |
| Steps (batches) per epoch | 32 |
| Train epochs | 100 |
| Optimizer | Nadam |
| Learning rate | 10⁻³ |
| Loss | NT-Xent |
| NT-Xent temperature (τ) | 0.1 |

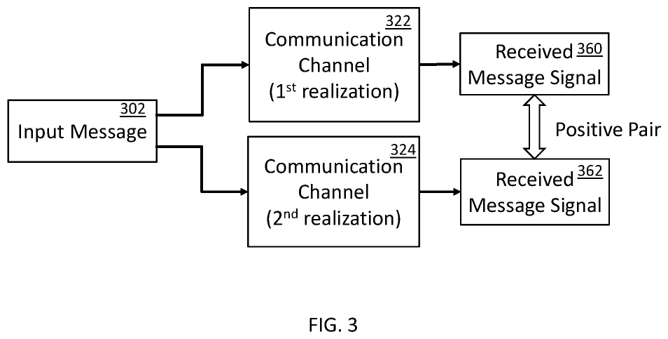

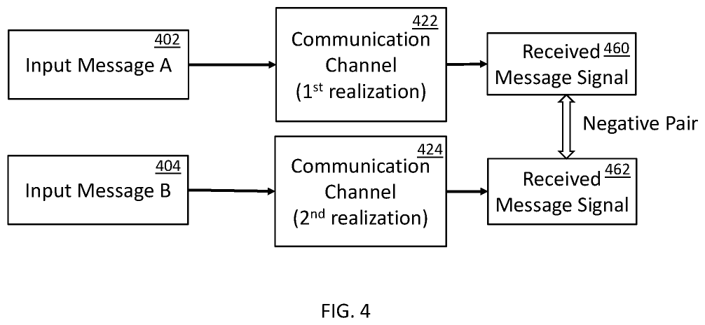

As discussed above, the self-supervised pretraining process relies on pairs of received message signals derived from transmitted messages. FIG. 3 illustrates an example methodology for generating positive pairs of received message signals using repeated transmissions of the same input message through a stochastic communication channel, while FIG. 4 illustrates an example methodology for generating negative pairs of received message signals using repeated transmissions of different input messages through a stochastic communication channel.

FIG. 3 is a representative schematic diagram illustrating generation of positive sample pairs for self-supervised contrastive pretraining using multiple transmissions of an input message through a communication channel.

In certain embodiments, an input message 302 is provided as a bit sequence or symbol sequence. The input message 302 is processed by a transmitter to generate a transmit signal that is propagated through the communication channel.

To generate multiple received message signals corresponding to the same transmitted message, the input message 302 is transmitted through the communication channel multiple times. As illustrated in FIG. 3, a first transmission is propagated through a first channel realization 322, and a second transmission is propagated through a second channel realization 324.

Because the communication channel is stochastic and time-varying in nature, the first channel realization 322 and the second channel realization 324 differ from one another. As a result, the corresponding received message signals 360 and 362 produced from the respective transmissions are not identical, even though they are derived from the same underlying input message 302.

The received message signals 360 and 362 form a positive pair for contrastive pretraining, as they correspond to the same transmitted message but include variations introduced by different channel realizations. In contrast, received message signals derived from different input messages form negative pairs.

In this manner, multiple transmissions of the same input message through a stochastic communication channel produce distinct received message signals that capture channel-induced variations. These variations enable the encoder model to learn representations that are robust to distortions introduced by the communication channel. Further, in this manner, the positive pairs reflect channel-induced variability of the same transmitted message rather than synthetic perturbations of a single received signal.

In certain embodiments, the channel realizations used to generate received message signals may vary according to different channel conditions, including variations in signal-to-noise ratio, multipath delay profiles, Doppler effects, and interference conditions. By sampling across diverse channel conditions, the resulting received message signals capture a wide range of channel-induced distortions, thereby improving the robustness of the learned representations. In some embodiments, channel realizations may be generated using stochastic channel models during pretraining, while in other embodiments they may be obtained from measurements in a physical communication environment.

While FIG. 3 illustrates generation of positive pairs from multiple transmissions of the same input message, FIG. 4 illustrates generation of negative pairs using received message signals derived from different input messages.

In certain embodiments, a first input message 402 and a second input message 404 are provided. The input messages 402 and 404 may correspond to different bit sequences or symbol sequences.

The input messages 402 and 404 are processed to generate corresponding transmit signals that are propagated through the communication channel. In certain embodiments, each input message is transmitted through the communication channel to produce a corresponding received message signal.

As illustrated in FIG. 4, the first input message 402 is transmitted through the first communication channel realization 422 to produce a first received message signal 460, and the second input message 404 is transmitted through the second communication channel realization 424 to produce a second received message signal 462.

Because the received message signals 460 and 462 are derived from different input messages, they represent distinct underlying transmitted information. Accordingly, the received message signals 460 and 462 form a negative pair for contrastive pretraining.

In this manner, received message signals derived from different transmitted messages can be used to train the encoder model to produce representation signals that are dissimilar for negative pairs, thereby improving discrimination between different transmitted messages.

### Stage 2: Supervised Neural Receiver Training

In this stage, labeled training samples are generated by transmitting known input messages through the transmitter 110 and the communication channel 120 to produce corresponding received message signals.

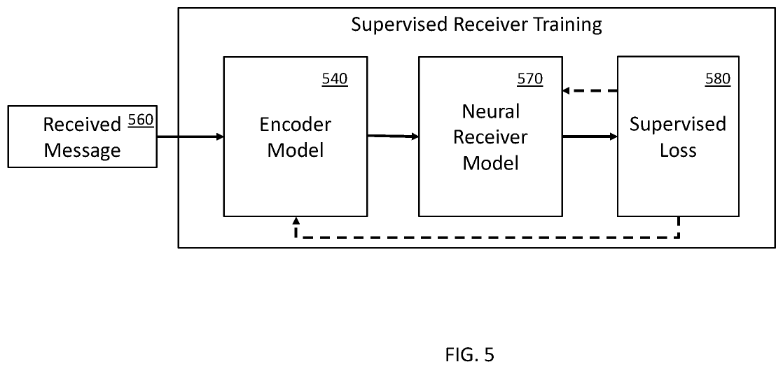

As illustrated in FIG. 5, a received message signal 560 is provided as input to the encoder model 540. The encoder model 540, which may have been trained using the self-supervised contrastive pretraining process described above, processes the received message signal 560 to produce a corresponding representation signal. The representation signal is provided as input to the neural receiver model 570, which processes the representation signal to produce a reconstructed output corresponding to the transmitted message.

A supervised loss component 580 is configured to compute a supervised loss based on a comparison between the reconstructed output and a corresponding known transmitted message. The supervised loss is used to update parameters of the neural receiver model 570 and, in certain embodiments, the encoder model 540 during supervised training.

Example architectural parameters for the neural receiver model 570 are provided in Table 5. In certain embodiments, the neural receiver model 570 comprises multiple dense (fully connected) layers with activation functions selected to provide sufficient expressive capability while maintaining architectural simplicity. The parameters shown in Table 5 are provided for illustrative purposes only, and other network architectures and configurations may be used without departing from the scope of the present disclosure.

TABLE 5
Receiver network parameters

| Layer | Outputs | Activation |
|---|---|---|
| Input | 128 | - - - |
| Dense | 512 | SELU |
| Dense | 512 | SELU |
| Dense | 104 | Linear |

In certain embodiments, the neural receiver model 570 produces a plurality of outputs corresponding to estimated values for transmitted bits. In one example embodiment, the neural receiver model 570 produces 104 outputs corresponding to log-likelihood ratio (LLR) values for each transmitted bit of an orthogonal frequency division multiplexing (OFDM) symbol. The output layer of the neural receiver model 570 may use a linear activation function such that each output directly represents a corresponding LLR value. In certain embodiments, hard decision decoding may be performed by thresholding the LLR values at zero to produce a reconstructed bit sequence.

Supervised training of the neural receiver model 570 can be performed using a loss function computed based on a comparison between the reconstructed output and the known transmitted message. In certain embodiments, the supervised loss comprises a binary cross-entropy loss computed from the LLR outputs.

Example supervised training parameters, including batch size, number of training steps per epoch, number of training epochs, optimizer type, and learning rate, are provided in Table 6. These parameters are provided for illustrative purposes only, and other training configurations may be used without departing from the scope of the present disclosure.

TABLE 6
Receiver training parameters

| Quantity | Value |
|---|---|
| Batch size | 1024 |
| Steps (batches) per epoch | 32 |
| Train epochs | 2000 |
| Optimizer | Nadam |
| Learning rate | 10⁻⁴ |
| Loss | Binary cross-entropy |
| | (from logits) |

In certain embodiments, the encoder model remains trainable during supervised training, allowing joint optimization of encoder and neural receiver parameters. In other embodiments, the encoder model is frozen after pretraining.

In operation, the trained encoder model and neural receiver model are configured to process received message signals to reconstruct transmitted messages. In contrast to approaches that perform classification of signal characteristics such as modulation type, the neural receiver model is configured to reconstruct transmitted messages from received message signals.

### Training Acceleration

In certain example implementations, self-supervised pretraining of the encoder model significantly reduces the number of supervised training epochs required for the neural receiver model to achieve a target bit-error-rate (BER) performance level under stochastic multipath channel conditions. In some instances, the reduction in supervised training epochs exceeds the number of epochs used during pretraining, resulting in an overall reduction in total training time.

In certain embodiments, performance improvements are observed across multiple channel models, including non-line-of-sight (NLOS) and line-of-sight (LOS) multipath channel conditions.

In certain channel conditions, allowing the encoder model to remain trainable during supervised training provides improved performance relative to configurations in which the encoder model is frozen after pretraining. These improvements facilitate more efficient training and adaptation of neural communication receivers in dynamic communication environments.

The foregoing description describes example embodiments of systems and methods for accelerating training of neural communication receivers. It is to be understood that the disclosed embodiments are illustrative and that the present disclosure is not limited to the specific architectures, network configurations, channel models, parameter selections, or training schemes described herein. Variations in neural network topology, activation functions, loss functions, optimization procedures, modulation formats, channel models, and system parameters may be employed without departing from the scope of the present disclosure.

In particular, although certain embodiments describe orthogonal frequency division multiplexing (OFDM) systems and specific tapped delay line channel models, the disclosed techniques may be applied to other modulation schemes, channel models, and communication system architectures. Similarly, although specific encoder, projection head, and neural receiver configurations are described, alternative neural network architectures capable of performing substantially similar representation learning and decoding functions may be employed.

Various alterations and modifications may be made without departing from the spirit and broader aspects of the invention as defined in the appended claims, which are to be interpreted in accordance with principles of patent law, including the doctrine of equivalents. The disclosure is presented for illustrative purposes and should not be interpreted as limiting the scope of the claims to the specific elements, structures, or algorithms described.

Unless expressly stated otherwise, references to elements in the singular are not intended to limit such elements to a single instance, and the use of terms such as “including,” “comprising,” or “having” is intended to be open-ended and encompass additional elements or steps.

The embodiments of the invention in which an exclusive property or privilege is claimed are defined as follows:

1. A system for receiving messages through a radio frequency (RF) communications channel, the system comprising:
RF interface circuitry configured to perform operations comprising
receiving, through the RF communications channel, RF signals carrying the messages, and
digitizing the received RF signals to produce message signals; and
a data processing apparatus configured to perform operations comprising:
pretraining an encoder model, by using contrastive self-supervised learning based on a first set of message signals, to form respective representation signals of the message signals, wherein the first set includes positive pairs of message signals associated with similar pretraining messages and negative pairs of message signals associated with dissimilar pretraining messages, wherein representation signals of a positive pair's message signals are similar and representation signals of a negative pair's message signals are dissimilar,
training a neural-receiver model, by using supervised learning based on a second set of message signals, to reconstruct training messages with which the second set's message signals are associated from representation signals formed by the pretrained encoder model from the second set's message signals,
obtaining a message signal associated with a test message,
applying the pretrained encoder model to the obtained message signal to form its representation signal, and applying the trained neural-receiver model to the obtained message signal's representation signal to reconstruct the test message with which the obtained message signal is associated, and
outputting the reconstructed test message.

2. The system of claim 1, wherein
the message signals of the positive pairs are associated with twice-transmitted pretraining messages, and
the message signals of the negative pairs are associated with pair-wise different pretraining messages.

3. The system of claim 1, wherein the operation of pretraining the encoder model by using contrastive self-supervised learning is further based on a similarity metric.

4. The system of claim 3, wherein the similarity metric comprises a cross-entropy loss.

5. The system of claim 1, wherein the operations performed by the data processing apparatus comprise implementing the encoder model as a neural network.

6. The system of claim 1, wherein the operation of pretraining the encoder model by using contrastive self-supervised learning comprises:
providing multiple received message signals corresponding to transmitted messages;
processing the received message signals using a shared encoder model to produce representation signals;
processing the representation signals using a projection head to produce projected vectors; and
computing a contrastive loss based on similarities between the projected vectors to update parameters of the encoder model.

7. The system of claim 1 wherein the operation of training the neural receiver model using supervised learning comprises:
providing received message signals corresponding to transmitted messages;
processing the received message signals using the encoder model to produce representation signals;
providing the representation signals to the neural receiver model to produce reconstructed outputs corresponding to the transmitted messages; and
computing a supervised loss based on a comparison between the reconstructed outputs and known transmitted messages to update parameters of the neural receiver model.

8. The system of claim 1 wherein the operations performed by the data processing apparatus comprise continuing to train the encoder model while training the neural-receiver model.

9. The system of claim 1 wherein the RF signals, received by the RF interface circuitry through the RF communications channel, carry the messages based on an orthogonal frequency division multiplexing protocol.

10. The system of claim 1, wherein the positive pairs are generated by transmitting a same input message through independent realizations of the communication channel.

11. The system of claim 10, wherein the independent realizations of the communication channel comprise stochastic variations in at least one of multipath fading, noise, or phase distortion.

12. A method for training and using a neural communication receiver, the method comprising:
receiving, through a radio frequency (RF) communications channel, RF signals carrying messages;
digitizing the received RF signals to produce message signals;
pretraining an encoder model by using contrastive self-supervised learning based on a first set of message signals to form respective representation signals of the message signals, wherein the first set includes positive pairs of message signals associated with similar pretraining messages and negative pairs of message signals associated with dissimilar pretraining messages, wherein representation signals of message signals in a positive pair are more similar than representation signals of message signals in a negative pair;
training a neural receiver model by using supervised learning based on a second set of message signals to reconstruct training messages associated with the second set of message signals from representation signals formed by the encoder model from the second set of message signals;
obtaining a message signal associated with a test message;
applying the encoder model to the obtained message signal to form a representation signal;
applying the neural receiver model to the representation signal to reconstruct the test message associated with the obtained message signal; and
outputting the reconstructed test message.

13. The method of claim 12, wherein the positive pairs are generated by transmitting a same input message through independent realizations of the RF communications channel.

14. The method of claim 13, wherein the negative pairs are generated from message signals corresponding to different input messages.

15. The method of claim 12, wherein pretraining the encoder model comprises:
processing multiple received message signals using a shared encoder model to produce representation signals;
processing the representation signals using a projection head to produce projected vectors; and
computing a contrastive loss based on similarities between the projected vectors to update parameters of the encoder model, the projection head, or both.

16. The method of claim 15 wherein the contrastive loss comprises a normalized temperature-scaled cross-entropy loss.

17. The method of claim 12, wherein training the neural receiver model comprises:
providing representation signals produced by the encoder model as inputs to the neural receiver model;
producing reconstructed outputs corresponding to transmitted messages; and
computing a supervised loss based on a comparison between the reconstructed outputs and known transmitted messages.

18. The method of claim 17, wherein the supervised loss comprises a binary cross-entropy loss computed from log-likelihood ratio outputs of the neural receiver model.

19. The method of claim 12, wherein the encoder model remains trainable during supervised training of the neural receiver model.

20. A non-transitory computer-readable medium storing instructions that, when executed by one or more processors, cause the one or more processors to perform operations comprising:
pretraining an encoder model by using contrastive self-supervised learning based on a first set of message signals to form respective representation signals of the message signals, wherein the first set includes positive pairs of message signals associated with similar pretraining messages and negative pairs of message signals associated with dissimilar pretraining messages;
training a neural receiver model by using supervised learning based on a second set of message signals, wherein the second set of message signals are processed by the encoder model to produce representation signals that are provided as inputs to the neural receiver model to reconstruct corresponding training messages; and
applying the encoder model and the neural receiver model to a message signal associated with a test message to reconstruct the test message.
